(19) United States
(12) Patent Application Publication
(10) Pub. No.: US 2012/0192734 A1
(43) Pub. Date: Aug. 2, 2012

(54) Stencil Printing Apparatus

(75) Inventor: Katsuaki Ono, Shibata-gun (JP)

(73) Assignee: RICOH COMPANY, LIMITED, Tokyo (JP)

(21) Appl. No.: 13/363,608

(22) Filed: Feb. 1, 2012

(30) Foreign Application Priority Data
Feb. 2, 2011 (JP) 2011-021061

(51) Int. Cl. B41F 15/04

(52) U.S. Cl. 101/115

(57) ABSTRACT

A stencil printing apparatus includes a plate cylinder, a printing pressure cylinder, and a pressing unit. The plate cylinder is rotated and driven together with a master wound therearound. The master has been subjected to plate making by a plate making unit. The printing pressure cylinder is pressed against the plate cylinder and is rotated due to the rotation of the plate cylinder. The pressing unit presses the printing pressure cylinder against the plate cylinder, thereby performing stencil printing on a printing sheet of paper delivered between the plate cylinder and the printing pressure cylinder with ink supplied from an inner part of the plate cylinder. The pressing unit is configured to be capable of individually setting pressing forces at one end and the other end in a width direction of the printing pressure cylinder, which are to be applied to the plate cylinder.

### CROSS-REFERENCE TO RELATED APPLICATIONS

The present application claims priority to and incorporates by reference the entire contents of Japanese Patent Application No. 2011-021061 filed in Japan on Feb. 2, 2011.

### BACKGROUND OF THE INVENTION

1. Field of the Invention

The present invention relates to a stencil printing apparatus and more particularly to a stencil printing apparatus capable of changing a pressing pressure of a printing pressure cylinder which is to be applied to a plate cylinder in a width direction of a recording sheet of paper.

2. Description of the Related Art

In a stencil printing apparatus, conventionally, a pressing pressure of a printing pressure cylinder which is to be applied to a plate cylinder is automatically regulated to obtain a constant density of an image to be printed on a recording sheet of paper.

Japanese Patent Application Laid-open No. 6-199028 describes a stencil printing apparatus provided with an ink type detecting unit for detecting a type of a printing ink to be supplied to an inside of a plate cylinder in order to carry out stencil printing in an equal printing density even if the type of the printing ink, particularly, a color of the printing ink is changed. In the stencil printing apparatus, a contact pressure of a press roller against a plate cylinder is variably set by means of a pressing pressure regulating motor depending on the type of the printing ink detected by the ink type detecting unit.

Moreover, Japanese Patent Application Laid-open No. 6-155882 describes a stencil printing apparatus provided with a contact pressure variable setting unit for variably setting a contact pressure of a press roller against a plate cylinder depending on a using state of the apparatus, for example, a non-using period of the stencil printing apparatus, the number of printed sheets in a single use or the like which is obtained by a using state detecting unit in order to automatically compensate for a printing density in relation to the using state of the stencil printing apparatus to carry out stencil printing in a desirable density irrespective of the using state of the stencil printing apparatus.

In a stencil printing apparatus, a printing density is varied in a position in a width direction of a sheet of paper which is orthogonal to a sheet passing direction, that is, along a rotating axis of a printing cylinder or a printing pressure cylinder for various reasons in some cases. For example, a density of an image formed on a printing sheet of paper differs on left and right in a width direction of a printing sheet of paper 15, that is, both directions which are orthogonal to the sheet passing direction toward the stencil printing apparatus as illustrated in FIG. 9. In an example illustrated in FIG. 9, the image density is high in a region 15a at a left side (a lower side in FIG. 9) in the sheet passing direction and is low in a region 15b at a right side (an upper side in FIG. 9). The difference in the printing density can be eliminated through a regulation of a pressing force of a printing pressure cylinder which is to be applied to a plate cylinder in a width direction of the printing sheet of paper.

Referring to the stencil printing apparatuses described in Japanese Patent Application Laid-open No. 6-199028 and Japanese Patent Application Laid-open No. 6-155882; however, there is a problem in that the regulation cannot be carried out easily and a difference in a density in a width direction cannot be eliminated readily if any.

Therefore, there is a need for a stencil printing apparatus capable of easily regulating a density of a printed image in a width direction of a sheet of paper.

### SUMMARY OF THE INVENTION

According to an embodiment, there is provided a stencil printing apparatus that includes a plate cylinder, a printing pressure cylinder, and a pressing unit. The plate cylinder is rotated and driven together with a master wound therearound. The master has been subjected to plate making by a plate making unit. The printing pressure cylinder is pressed against the plate cylinder and is rotated due to the rotation of the plate cylinder. The pressing unit presses the printing pressure cylinder against the plate cylinder, thereby performing stencil printing on a printing sheet of paper delivered between the plate cylinder and the printing pressure cylinder with ink supplied from an inner part of the plate cylinder. The pressing unit is configured to be capable of individually setting pressing forces at one end and the other end in a width direction of the printing pressure cylinder, which are to be applied to the plate cylinder.

According to another embodiment, there is provided a stencil printing apparatus that includes a plate cylinder, a printing pressure cylinder, and a pressing unit. The plate cylinder is rotated and driven together with a master wound therearound. The master has been subjected to plate making by a plate making unit. The printing pressure cylinder is caused to come in pressure contact with the plate cylinder and rotated due to the rotation of the plate cylinder. The pressing unit presses the printing pressure cylinder against the plate cylinder, thereby perfoming stencil printing on a printing sheet of paper delivered between the plate cylinder and the printing pressure cylinder with ink supplied from an inner part of the plate cylinder. The pressing unit includes a pressing member for applying a pressing force of the printing pressure cylinder against the plate cylinder to one of both ends in a width direction of the printing pressure cylinder; and a pressing force setting unit that sets the pressing force of the pressing member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view illustrating a basic structure of a stencil printing apparatus to which an example is applied;

FIG. 2 is a front view illustrating the stencil printing apparatus according to a first example;

FIG. 3 is a side view illustrating the stencil printing apparatus;

FIG. 4 is a block diagram illustrating a control system of the stencil printing apparatus;

FIG. 5 is a front view illustrating a stencil printing apparatus according to a second example;

FIG. 6 is a side view illustrating the stencil printing apparatus;

FIG. 7 is a front view illustrating a stencil printing apparatus according to a third example;

FIG. 8 is a side view illustrating the stencil printing apparatus; and

FIG. 9 is a typical view illustrating a drawback of a printing state.

### DETAILED DESCRIPTION OF THE PREFERRED EMBODIMENTS

Various embodiment of a stencil printing apparatus according to the present invention will be described below.

### First Embodiment

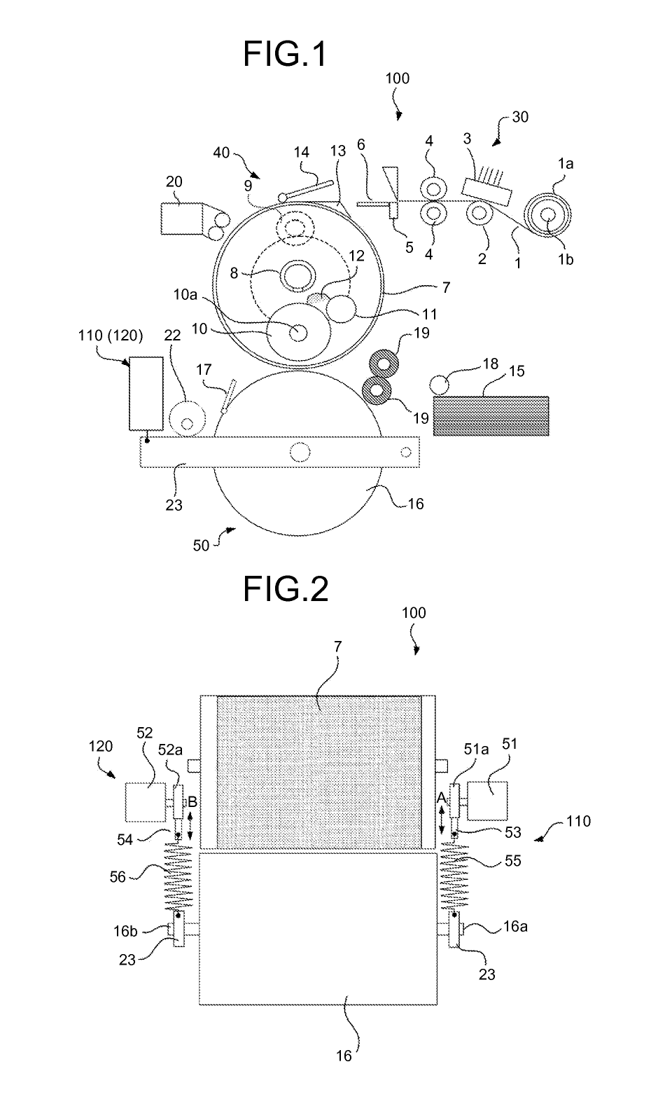

A stencil printing apparatus 100 according to a first embodiment will be described below with reference to the drawings. First, a basic structure of the stencil printing apparatus 100 will be described. FIG. 1 is a sectional view illustrating the stencil printing apparatus 100. The stencil printing apparatus 100 includes a plate making unit 30 for carrying out plate making for a master 1, a printing unit 40 for causing ink exude from perforations in the master 1, thereby carrying out printing, and a pressing unit 50 for pressing a printing sheet of paper 15 against the printing unit 40. The master 1 is wound as a roll 1a around a roll core 1b and has the roll core 1b supported rotatably by a holder unit which is not illustrated.

The plate making unit 30 includes a platen roller 2, a thermal head 3 having a large number of heat generating elements, a pair of feed rollers 4 and 4, a cutter 5, and a guide plate 6. The platen roller 2 is rotatably supported on a side plate (not illustrated) of the plate making unit and is driven in a counterclockwise direction by means of a stepping motor (not illustrated). Moreover, the thermal head 3 is pressed against the platen roller 2 by means of a spring member (not illustrated), and the master 1 is sent from the roll 1a and is delivered between the platen roller 2 and the thermal head 3, and is thermally perforated by means of the thermal head 3 based on image information.

The pair of feed rollers 4 and 4 is disposed on a downstream side of the platen roller 2 in a master delivery direction and has a delivering speed set to be higher than that of the platen roller 2, and is supported rotatably in a pressure contact state by means of the side plate of the plate making unit (not illustrated). The pair of feed rollers 4 and 4 delivers the master 1 with sliding and applies a predetermined tension to the master 1. The cutter 5 is disposed on the downstream side of the pair of feed rollers 4 and 4. As the cutter 5, a vertical blades guillotine type or a rotating blade moving type which serves to cut the master 1 to have a proper length is employed. The guide plate 6 is fixedly provided between the side plates of the plate making unit (not illustrated), and serves to guide a tip of the master 1.

The printing unit 40 is disposed on a downstream side of the plate making unit 30. The printing unit 40 includes a plate cylinder 7. The plate cylinder 7 has a structure in which porous support cylinder members and mesh screens covering an outer periphery thereof and formed by a resin or a metal mesh material (not illustrated) are wound. Moreover, the plate cylinder 7 is fixed to left and right of a flange (not illustrated) which is supported rotatably around an ink pipe 8, and is rotated and driven in a counterclockwise direction by means of a driving motor 9. The ink pipe 8 is supported on a side plate of a main body (not illustrated).

Furthermore, inside the plate cylinder 7, an ink roller 10 having a shaft unit 10a supported rotatably by means of an ink roller side plate pair (not illustrated) fixed to the ink pipe 8 is rotated and driven in the same direction synchronously with the plate cylinder 7 by means of a gear, a belt and the like which are a drive transmitting unit (not illustrated). A doctor roller 11 is provided with a slight clearance formed from an outer peripheral surface of the ink roller 10, and ink in an ink reservoir 12 formed between the ink roller 10 and the doctor roller 11 is supplied to the outer peripheral surface of the ink roller 10. The ink in the ink reservoir 12 is sucked by an ink pack or the like through an ink supplying device (not illustrated), and is supplied to the ink reservoir 12 through a supplying hole of the ink pipe 8 and is thus kneaded.

Moreover, a stage 13 formed of a magnetic material is provided along a single bus line of the plate cylinder 7. A clamper shaft is rotatably supported on the stage 13 in parallel with the stage 13, and a clamper 14 having a magnet or the like stuck thereto is fixed integrally, and is opened/closed in a predetermined position by means of an opening/closing device (not illustrated).

The pressing unit 50 is disposed on a lower side of the plate cylinder 7. The pressing unit 50 selectively abuts on the plate cylinder 7 to press the printing sheet of paper 15 when the printing sheet of paper 15 is fed. The pressing unit 50 includes a printing pressure cylinder 16 supported by a printing pressure arm 23 and a resist roller 18 for inserting the printing sheet of paper 15 fed by a paper feeding unit (not illustrated) into a portion between the plate cylinder 7 and the printing pressure cylinder 16 or the like in a timing. The reference numeral 19 in the drawing denotes a plate discharging unit for discharging the used master.

Next, description will be given to a basic operation of the stencil printing apparatus 100. When a document is set into a document scanning unit (not illustrated) and a start signal start button or the like is pressed down, the used master (not illustrated) is peeled and discarded from a surface of the plate cylinder 7 by means of the plate discharging unit 19 while the plate cylinder 7 is rotated by the driving motor 9. The plate cylinder 7 is rotated until a paper clamper 17 reaches an almost overhead position, and is then stopped.

When the plate cylinder 7 is stopped, the clamper 14 is opened by the opening/closing unit (not illustrated) so that a plate feeding standby state is brought. The document is fed to the document scanning unit, and a pulse current is applied to the heat generating element of the thermal head 3 depending on image information via a plate making control unit or the like and is thus operated in a main-scanning direction, and furthermore, a stepping motor (not illustrated) is rotated to deliver the master 1 by means of the platen roller 2 and the feed roller 4 in a sub-scanning direction so that a thermal film of the master 1 is thermally perforated and plate making is thus carried out. Subsequently, the master 1 is guided to the guide plate 6 so that the tip of the master 1 is guided to a portion between the stage 13 and the clamper 14.

When it is determined, based on the number of steps of the stepping motor (not illustrated), that the tip of the master 1 reaches the stage 13, then, the clamper 14 is closed by the opening/closing unit (not illustrated) to suck and interpose the tip of the master 1, and the plate cylinder 7 is rotated at an almost equal speed to a master delivering speed so that the master 1 subjected to the plate making is wound. When it is determined, based on the number of the steps of the stepping motor (not illustrated), that the plate making is ended, thereafter, the cutter 5 is operated so that the master 1 is cut, and furthermore, the platen roller 2 and the feed roller 4 are stopped so that the cut master is pulled out of the plate cylinder 7, and the operation for carrying out winding around the plate cylinder 7 is completed.

When the master 1 is completely wound around the plate cylinder 7, the single printing sheet of paper 15 is fed from a paper feeding unit, is timed by the resist roller 18, is interposed by the paper clamper 17 provided on the printing pressure cylinder 16, and is inserted between the plate cylinder 7 and the printing pressure cylinder 16. The feed of the printing sheet of paper 15 is detected by a paper detecting unit (not illustrated) so that an engaging unit of the printing pressure arm 23 is released. The printing pressure arm 23 is driven and swung by a printing pressure cam 22 which is to be rotated in a simultaneous timing with the printing pressure cylinder 16, and the printing pressure cylinder 16 is pressed against the plate cylinder 7 by means of a first pressing member 110 and a second pressing member 120 which are disposed on both ends thereof. Consequently, the printing sheet of paper 15 is continuously pressed against the plate cylinder 7 so that the wound master 1 comes in close contact with the plate cylinder 7, and an image is thus formed. The printing sheet of paper 15 is discharged by an opening/closing operation of the paper clamper 17 or the like. The two pressing members 110 and 120 can regulate their pressing forces independently.

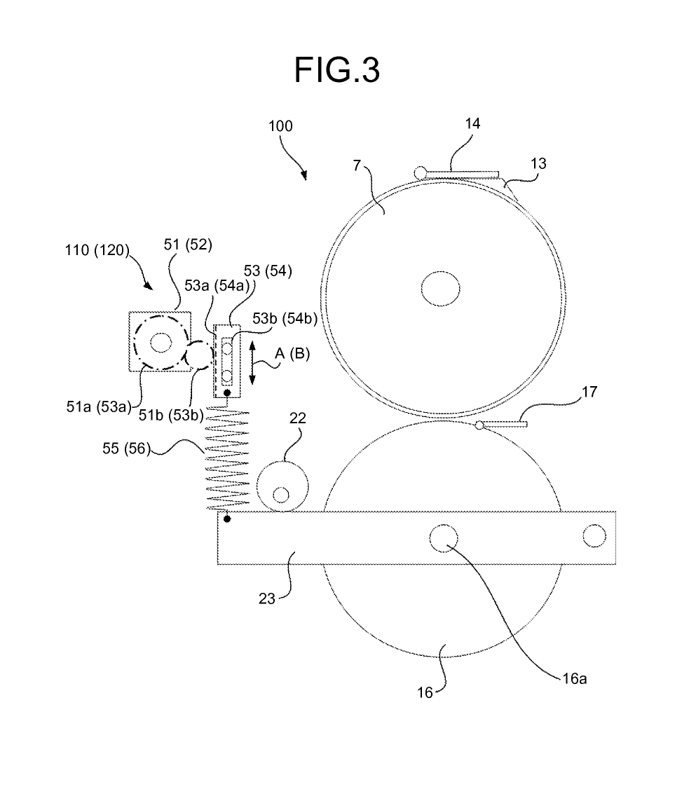

Next, the first pressing member 110 and the second pressing member 120 will be described. FIG. 2 is a side view illustrating the stencil printing apparatus according to the first embodiment and FIG. 3 is a front view illustrating the stencil printing apparatus. In the stencil printing apparatus 100 according to the first embodiment, the first pressing member 110 is disposed on one end 16a of the rotating shaft of the printing pressure cylinder 16, and the second pressing member 120 is disposed on the other end 16b, and they serve to press the printing pressure cylinder 16 toward the plate cylinder 7 side. The first pressing member 110 includes a printing pressure changing motor 51 constituted by a stepping motor, a rack member 53 for changing a rotating motion of the printing pressure changing motor 51 into a rectilinear motion, and a tension spring 55 for pulling the printing pressure arm 23 toward the plate cylinder 7 side.

Moreover, the second pressing member 120 includes a printing pressure changing motor 52 constituted by a stepping motor, a rack member 54 for changing a rotating motion of the printing pressure changing motor 52 into a translational motion, and a tension spring 56 for pulling the printing pressure arm 23 toward the plate cylinder 7 side.

As illustrated in FIG. 3, the rotation of the printing pressure changing motor 51 (52) is transmitted to a spur gear 51b (53b) to be engaged with the rack member 53 (54) from a pinion 51a (53a). In the rack member 53 (54), there is formed a rack tooth 53a (54a) to be engaged with the spur gear 51b (53b), and is also formed a rectilinear moving guide section 53b (54b). The rack member 53 (54) carries out a rectilinear motion (arrows A and B in FIG. 2) through the rotation of the printing pressure changing motor 51 (52). Consequently, the pressing force of the printing pressure arm 23 against the paper clamper 17 side through the tension spring 55 (56) is regulated. In the stencil printing apparatus 100 according to the first embodiment, the printing pressure changing motors 51 and 52 are disposed on both left and right of the printing pressure cylinder 16 and can be controlled independently. Therefore, the pressing forces at both ends in a width direction of the printing pressure cylinder 16 toward the plate cylinder 7 can be regulated simultaneously or individually.

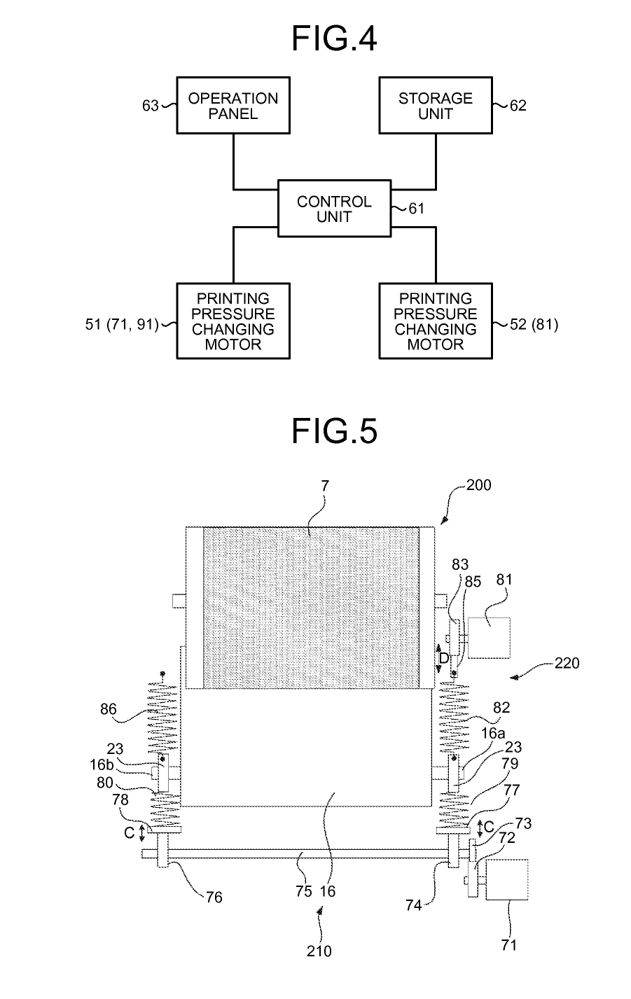

Next, description will be given to the control of the first pressing member 110 and the second pressing member 120. FIG. 4 is a block diagram illustrating a control system of the stencil printing apparatus according to the first embodiment. In the stencil printing apparatus 100 according to the first embodiment, driving amounts of the printing pressure changing motors 51 and 52 are controlled by a control unit 61 serving as a pressing force setting unit. A storage unit 62 storing therein a driving condition and an operation panel 63 to which an instruction of an operator is to be input are connected to the control unit 61.

The control unit 61 is constituted as a computer including a CPU, ROM, RAM and the like. In the control unit 61, the CPU executes a program stored in the RAM, thereby controlling the driving operations of the printing pressure changing motors 51 and 52 based on an instruction sent from the operation panel 63, and furthermore, controlling the driving operations of the printing pressure changing motors 51 and 52 automatically with reference to the driving condition stored by the storage unit 62.

The storage unit 62 stores therein, as printing pressure regulating data, each of printing conditions of the respective printing pressure changing motors 51 and 52, for example, a driving amount corresponding to a temperature of ink, a printing speed or the like, and the control unit 61 calculates and acquires the driving amounts of the printing pressure changing motors 51 and 52 by referring to the storage unit 62.

According to the stencil printing apparatus 100 of the first embodiment, therefore, in the case where a difference in a density in a width direction is generated over a printed image, the printing pressure changing motors 51 and 52 are individually driven by the control unit 61 in order to eliminate the difference. Consequently, the difference in a density of the image in the width direction is eliminated. By driving the printing pressure changing motors 51 and 52 at the same time, it is possible to wholly change the pressing force of the printing pressure cylinder 16 against the plate cylinder 7. The printing pressure changing motors 51 and 52 can be controlled in accordance with an instruction input from the operation panel 63, and furthermore, can be automatically controlled by the control unit 61. In this case, the printing pressure regulation data is stored in advance in the storage unit 62.

The individual printing pressure regulation data for setting the pressing force on both sides in the width direction which is once used for regulation can be stored, in the storage unit 62, as peculiar data to the plate cylinder. Moreover, the storage unit 62 may be disposed on the apparatus body side or the plate cylinder side.

In the case where the storage unit 62 is disposed on the apparatus body side, it is possible to store identification data on the plate cylinder to be exchanged every printing color and peculiar printing pressure regulation data to the plate cylinder in associated with each other. Consequently, it is possible to carry out a regulation corresponding to the plate cylinder to be exchanged for printing in a plurality of colors. In the case where the printing pressure regulation is carried out again over a plate cylinder which is reattached after the regulation, the printing pressure regulation data is additionally stored or overwritten.

According to the stencil printing apparatus 100 of the first embodiment, in the case where a regulation is once carried out so that a plate cylinder having individual left and right printing pressure regulation data stored in the storage unit is attached, the control unit of the apparatus body reads the printing pressure regulation data corresponding to the plate cylinder and automatically carries out control to variably regulate printing pressures individually on left and right based on the printing pressure regulation data. With such a structure, even if a plurality of plate cylinders is provided, it is possible to omit a great deal of time and labor for individually regulating the left and right parts every time the plate cylinder is attached.

### Second Embodiment

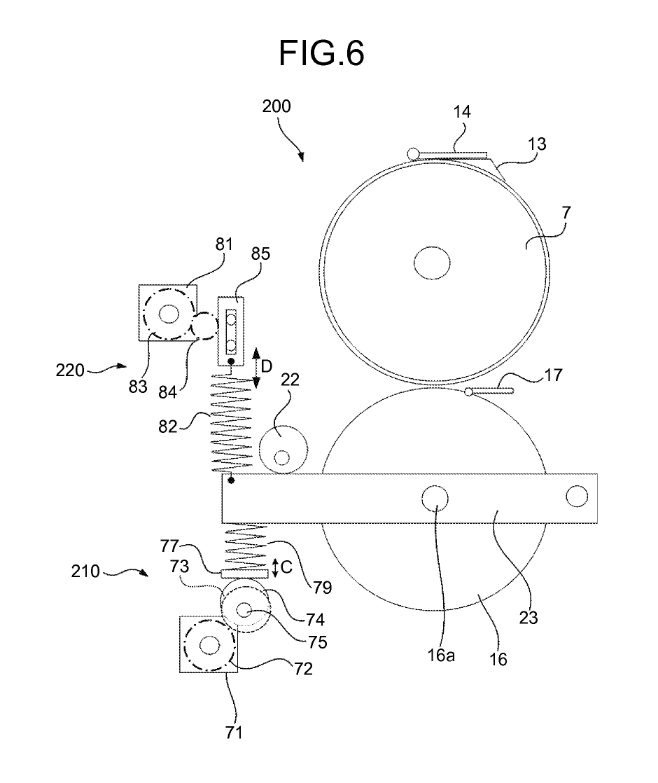

Next, description will be given to a stencil printing apparatus 200 according to a second embodiment. FIG. 5 is a plan view illustrating the stencil printing apparatus 200, and FIG. 6 is a side view illustrating the stencil printing apparatus 200. The stencil printing apparatus 200 includes a first pressing member 210 connected to an end 16a and the other end 16b in a printing pressure cylinder 16 for wholly pressing the printing pressure cylinder 16 against a plate cylinder 7, and a second pressing member 220 connected to the end 16a of the printing pressure cylinder 16 for regulating a pressing force at the end 16a side of the printing pressure cylinder 16.

The first pressing member 210 includes compression springs 79 and 80 for pressing the printing pressure cylinder 16 against the plate cylinder 7 by the same force as two printing pressure arms 23 connected to the end 16a and the other end 16b of a rotating shaft in the printing pressure cylinder 16, a printing pressure changing motor 71 for changing compression amounts of the compression springs 79 and 80, cams 74 and 76 to be rotated and driven by the printing pressure changing motor 71, a shaft 75 for coupling these cams 74 and 76 to each other, and compression plates 77 and 78 for changing dimensions of the compression springs 79 and 80 in contact with the cams 74 and 76. A spur gear 73 disposed coaxially with the cam 74 is engaged with a pinion 72 to be driven by the printing pressure changing motor 71 so that the cam 74 is rotated and driven.

The second pressing member 220 includes a printing pressure changing motor 81 constituted by a stepping motor, a tension spring 82 for pulling the printing pressure arm 23 connected to the end 16a, and a rack member 85 for converting a rotation of the printing pressure changing motor 81 into a rectilinear motion. The rack member 85 is driven by a pinion 83 to be driven by the printing pressure changing motor 81 and a spur gear 84 to be engaged with the pinion 83, and has the same structure as the rack member 53 according to the first embodiment. Moreover, the printing pressure changing motors 71 and 81 are controlled by means of the control system illustrated in FIG. 4 in the same manner as in the first embodiment.

According to the stencil printing apparatus 200 of the second embodiment, therefore, the printing pressure changing motor 71 is controlled to be driven so that lengths of the compression springs 79 and 80 are changed (an arrow C in FIG. 5). Thus, it is possible to regulate a printing pressure of the whole printing pressure cylinder 16 which is to be applied to the plate cylinder 7. By controlling the driving operation of the printing pressure changing motor 81 to move the rack member 85, thereby changing a length of the tension spring 82 (an arrow D in FIG. 5) and varying a pressing force on the end 16a side, then, it is possible to regulate a state of the pressing force at the sides of the end 16a and the other end 16b. The regulation can also be carried out in reverse order.

According to the stencil printing apparatus 200 of the second embodiment, in the same manner as in the first embodiment, it is possible to freely change the printing pressure of the printing pressure cylinder as a whole, and furthermore, to freely vary a balance of the printing pressure to be applied to the end in the width direction of the printing pressure cylinder. Therefore, it is possible to easily carry out a correction even in the case where a difference in a density is generated in a width direction of an image formed on a printing sheet of paper.

### Third Embodiment

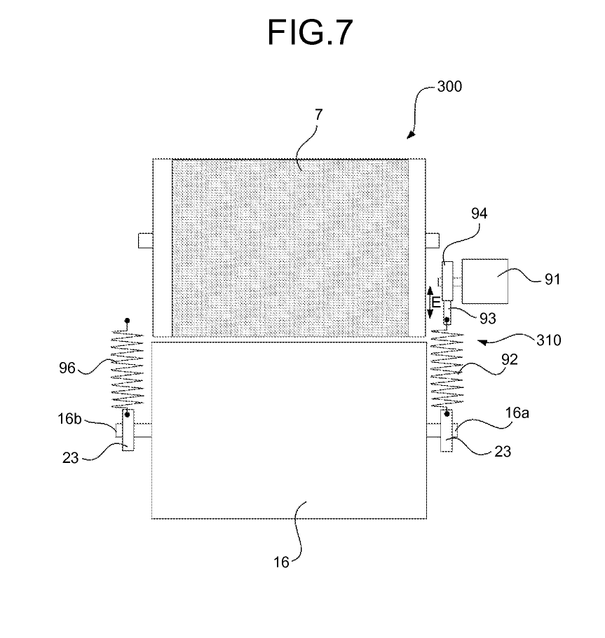

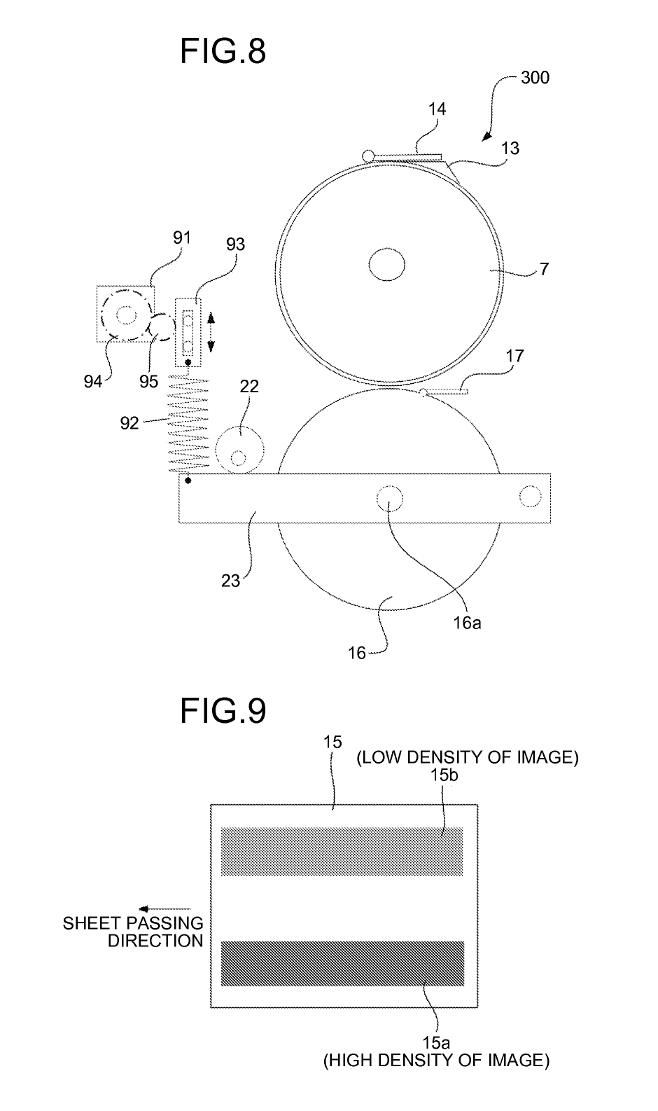

Next, a stencil printing apparatus according to a third embodiment 300 will be described. FIG. 7 is a front view illustrating the stencil printing apparatus 300 and FIG. 8 is a side view illustrating the stencil printing apparatus 300. In the stencil printing apparatus 300 according to the third embodiment, a pressing member 310 including a tension spring 92 is disposed on a printing pressure arm 23 connected to an end 16a of a printing pressure cylinder 16, a tension spring 96 is disposed on a printing pressure arm 23 connected to the other end 16b, and a certain pressing force against a plate cylinder 7 is wholly applied to the printing pressure cylinder 16.

The pressing member 310 includes the tension spring 92, a printing pressure changing motor 91 constituted by a stepping motor, and a rack member 93 to be driven by the printing pressure changing motor 91, and serves to regulate a tensile force at the end 16a side of the printing pressure cylinder 16. The rack member 93 has the same structure as that of the rack member 53, and carries out a rectilinear motion by means of a spur gear 95 to be rotated and driven by a pinion 94 which is to be rotated and driven through the printing pressure changing motor 91. Moreover, the printing pressure changing motor 91 is controlled to be driven by the control system illustrated in FIG. 4 in the same manner as in the first embodiment.

In the stencil printing apparatus 300 according to the third embodiment, the pinion 94 and the spur gear 95 are rotated by the rotation of the printing pressure changing motor 91 so that the rack member 93 thus carries out a rectilinear motion. Therefore, a length of the tension spring 92 at the end 16a side of the printing pressure cylinder 16 is varied (an arrow E in FIG. 7) so that a tensile force is regulated. Consequently, it is possible to regulate a balance of a printing pressure to be applied to the plate cylinder 7 in a width direction of the printing pressure cylinder 16.

According to the stencil printing apparatus 300 of the third embodiment, it is possible to freely change the balance of the printing pressure to be applied to the end in the width direction of the printing pressure cylinder with a simple structure. Also even in the case where a difference in a density is generated in a width direction of an image formed on a printing sheet of paper, it is possible to easily carry out a correction of the difference.

According to the present invention, in the stencil printing apparatus, it is possible to freely change a printing pressure of a printing pressure cylinder as a whole, and furthermore, to freely vary a state of the printing pressure to be applied to an end in a width direction of the printing pressure cylinder. Therefore, even in the case where a difference in a density is generated in a width direction of an image formed on a printing sheet of paper, it is possible to easily carry out a correction of the difference.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A stencil printing apparatus comprising:
a plate cylinder that is rotated and driven together with a master wound therearound, the master having been subjected to plate making by a plate making unit;
a printing pressure cylinder that is pressed against the plate cylinder and is rotated due to the rotation of the plate cylinder; and
a pressing unit that presses the printing pressure cylinder against the plate cylinder, thereby performing stencil printing on a printing sheet of paper delivered between the plate cylinder and the printing pressure cylinder with ink supplied from an inner part of the plate cylinder,
wherein the pressing unit is configured to be capable of individually setting pressing forces at one end and the other end in a width direction of the printing pressure cylinder, which are to be applied to the plate cylinder.

2. The stencil printing apparatus according to claim 1, wherein the pressing unit includes:
pressing members disposed on the both ends in the width direction of the printing pressure cylinder for changing the pressing forces, respectively; and
a pressing force setting unit that sets the pressing forces of the pressing members.

3. The stencil printing apparatus according to claim 1, wherein the pressing unit includes:
a first pressing member that simultaneously changes the pressing forces at the both ends of the printing pressure cylinder;
a second pressing member that changes the pressing force at one of the ends in a state in which the first pressing member presses the printing pressure cylinder against the plate cylinder with a set pressing force; and
a pressing force setting unit that sets the pressing forces of the first pressing member and the pressing force of the second pressing member.

4. The stencil printing apparatus according to claim 2, wherein the pressing force setting unit includes:
a storage unit that stores therein printing pressure regulation data that specifies the pressing forces of each of the pressing members corresponding to each of various printing conditions; and
a control unit that controls the pressing members based on the printing pressure regulation data.

5. The stencil printing apparatus according to claim 3, wherein the pressing force setting unit includes:
a storage unit that stores therein printing pressure regulation data that specifies the pressing forces of each of the first and second pressing members corresponding to each of various printing conditions; and
a control unit that controls the first and second pressing members based on the printing pressure regulation data.

6. The stencil printing apparatus according to claim 4, wherein the printing pressure regulation data which depends on the printing condition including a temperature of a printing ink and a printing speed, and
the control unit controls the pressing members depending on the printing condition.

7. The stencil printing apparatus according to claim 5, wherein the storage unit stores therein the printing pressure regulation data which depends on the printing condition including a temperature of a printing ink and a printing speed, and
the control unit controls the first and second pressing members depending on the printing condition.

8. The stencil printing apparatus according to claim 4, further comprising a measuring unit that measures a time period for which the stencil printing apparatus is left,
wherein the storage unit stores therein setting values of the pressing forces of the pressing members, which correspond to a length of the measured time period, and
wherein the control unit controls the pressing members based on the setting values.

9. The stencil printing apparatus according to claim 5, further comprising a measuring unit that measures a time period for which the stencil printing apparatus is left,
wherein the storage unit stores therein setting values of the pressing forces of the first and second pressing members, which correspond to a length of the measured time period, and
wherein the control unit controls the first and second pressing members based on the setting values.

10. The stencil printing apparatus according to claim 4,
wherein the plate cylinder is exchangeable with any one of a plurality of plate cylinders used for carrying out printing in a different color,
wherein the storage unit stores therein the setting values of the pressing forces of the pressing members, which are adapted to each of the plate cylinders, and
wherein the control unit detects an installed plate cylinder and controls the pressing members based on the setting values which are adapted to the detected plate cylinder.

11. The stencil printing apparatus according to claim 5,
wherein the plate cylinder is exchangeable with any one of a plurality of plate cylinders used for carrying out printing in a different color,
wherein the storage unit stores therein the setting values of the pressing forces of the first and second pressing members, which are adapted to each of the plate cylinders, and
wherein the control unit detects an installed plate cylinder and controls the first and second pressing members based on the setting values which are adapted to the detected plate cylinder.

12. A stencil printing apparatus comprising:
a plate cylinder that is rotated and driven together with a master wound therearound, the master having been subjected to plate making by a plate making unit;
a printing pressure cylinder that is caused to come in pressure contact with the plate cylinder and rotated due to the rotation of the plate cylinder; and
a pressing unit that presses the printing pressure cylinder against the plate cylinder, thereby perfoming stencil printing on a printing sheet of paper delivered between the plate cylinder and the printing pressure cylinder with ink supplied from an inner part of the plate cylinder,
wherein the pressing unit includes:
a pressing member for applying a pressing force of the printing pressure cylinder against the plate cylinder to one of both ends in a width direction of the printing pressure cylinder; and
a pressing force setting unit that sets the pressing force of the pressing member.

13. The stencil printing apparatus according to claim 12, wherein the pressing force setting unit includes:
a storage unit that stores therein printing pressure regulation data that specifies the pressing force of the pressing member corresponding to each of various printing conditions; and
a control unit that controls the pressing member based on the printing pressure regulation data.

14. The stencil printing apparatus according to claim 13, wherein the storage unit stores therein the printing pressure regulation data which depends on the printing condition including a temperature of a printing ink and a printing speed, and
the control unit controls the pressing member depending on the printing condition.

15. The stencil printing apparatus according to claim 13, further comprising a measuring unit that measures a time period for which the stencil printing apparatus is left,
wherein the storage unit stores therein a setting value of the pressing force, which corresponds to a length of the measured time period, and
wherein the control unit controls the pressing member based on the setting value.

16. The stencil printing apparatus according to claim 13,
wherein the plate cylinder is exchangeable with any one of a plurality of plate cylinders used for carrying out printing in a different color,
wherein the storage unit stores therein the setting value of the pressing force which is adapted to each of the plate cylinders, and
wherein the control unit detects an installed plate cylinder and controls the pressing force based on the setting value which is adapted to the detected plate cylinder.
